(19) United States
(12) Patent Application Publication
(10) Pub. No.: US 2003/0058325 A1
(43) Pub. Date: Mar. 27, 2003

(54) Electrophotographic apparatus

(75) Inventor: Tamio Fukui, Kyoto (JP)

Correspondence Address: McDermott, Will & Emery, 600 13th Street, N.W., Washington, DC, 20005-3096, US

(73) Assignee: Dainippon Screen Mfg. Co., Ltd.

(21) Appl. No.: 10/235,823

(22) Filed: Sep. 6, 2002

(30) Foreign Application Priority Data
Sep. 21, 2001 (JP) 2001-288561

(51) Int. Cl. G03G 15/00

(52) U.S. Cl. 347/133; 347/140; 399/48

(57) ABSTRACT

An electrophotographic apparatus includes a controller having an image processor and an image storage unit. The controller is connected to a recording head having a light source and a light source driver, and to a surface electrometer. Based on surface potentials of a latent image area on a photoreceptor measured by the surface electrometer, the image processor of the controller processes image signals stored in the image storage unit or controls the light source driver to correct the intensity of a light beam emitted from the light source.

### BACKGROUND OF THE INVENTION

1. Field of the Invention

The present invention relates to electrophotographic apparatus such as electronic copiers and electronic printers.

2. Description of the Related Art

Such an electrophotographic apparatus emits light beams to a photoreceptor formed peripherally of an electrostatic drum, a photoreceptor in sheet form or a photoreceptor in belt form to form an electrostatic latent image thereon, and develops the latent image into a toner image by placing the photoreceptor in contact with a toner. The toner adhering to the photoreceptor after the developing step is transferred to printing paper or the like in a transfer step, and thereafter fixed to the printing paper or the like in a fixing step.

Such an electrophotographic apparatus includes a recording head with a light source in the form of an LED or laser light source, for example, and optics having a condenser lens for concentrating a light beam emitted from the light source on a photoreceptor formed peripherally of an electrostatic drum. The recording head emits a light beam modulated in response to image signals transmitted from an image signal generating device.

In such an electrophotographic apparatus, a proper quantity of light from the recording head is set beforehand based on a gamma curve representing light attenuation on the photoreceptor. However, the sensitivity of the photoreceptor is variable with a degree of fatigue thereof, and the temperature and humidity of a room in which the electrophotographic apparatus is installed.

The quantity of light set beforehand will therefore deviate from a proper quantity of light at any given time. This results in a phenomenon that an image density after a continuous printing operation proves different from an image density at the beginning of the printing operation, or the density of images printed varies from day to day. Such a phenomenon becomes particularly outstanding with an exposure unit of high resolution, and with a photoreceptor having a light attenuation characteristic of high gamma level.

To deal with such a problem, it has been conventional practice that the operator repeatedly measures densities of print outputs from time to time, and manually adjusts image data according to density measurements. However, not only is such an operation extremely cumbersome, but the density of prints would vary during an interval between the times of measurement. Such a drawback is particularly serious in time of fast printing for performing a large amount of printing per unit time.

In some electrophotographic apparatus, density is adjusted by using only regions of the photoreceptor free from an attenuation of potential or by using only regions having undergone an attenuation of potential. However, this cannot cope with variations occurring after the attenuation, leaving the drawback of failing to deal with density variations occurring with variations in sensitivity curve.

### SUMMARY OF THE INVENTION

The object of the present invention, therefore, is to provide an electrophotographic apparatus for outputting prints with a constant density at all times.

The above object is fulfilled, according to the present invention, by an electrophotographic apparatus for emitting a light beam to a photoreceptor to form an electrostatic latent image thereon, and thereafter supplying a toner to the photoreceptor to develop the latent image, the apparatus comprising a charger for charging the photoreceptor; a controller having an image processor and an image storage unit, the image storage unit storing image signals received from an image signal generator, and a sample pattern for forming on the photoreceptor a latent image area having a mixture of potential attenuated areas and potential unattenuated areas, the image processor creating image data for forming an electrostatic latent image based on the image signals received from the image signal generator; a recording head having a light source, and a light source driver for driving the light source, the recording head forming an electrostatic latent image on the photoreceptor charged by the charger by irradiating the photoreceptor with a light beam modulated according to the image data supplied from the image processor; and a surface potential measuring unit for measuring surface potentials of the photoreceptor, the surface potential measuring unit measuring surface potentials of the latent image area having a mixture of potential attenuated areas and potential unattenuated areas obtained by emitting a light beam from the recording head to the photoreceptor by using the sample pattern stored in the image storage unit; wherein the controller corrects at least one of intensity of the light beam emitted from the recording head and the image data supplied to the recording head, based on the surface potentials of the latent image area measured by the surface potential measuring unit.

With this electrophotographic apparatus, the density of prints outputted may be maintained constant at all times even when the sensitivity of the photoreceptor varies.

In a preferred embodiment of the invention, the controller corrects the intensity of the light beam emitted from the light source by controlling the light source driver based on the surface potentials of the latent image area.

In a different embodiment of the invention, the controller corrects the image data supplied to the recording head by causing the image processor to process the image signals stored in the image storage unit based on the surface potentials of the latent image area.

In another aspect of the invention, an electrophotographic apparatus is provided for emitting a light beam to a photoreceptor to form an electrostatic latent image thereon, and thereafter supplying a toner to the photoreceptor to develop the latent image, the apparatus comprising a charger for charging the photoreceptor; a recording head for forming an electrostatic latent image on the photoreceptor charged by the charger by irradiating the photoreceptor with a light beam modulated according to image data supplied to the recording head; a surface potential measuring unit for measuring surface potentials of a latent image area having a mixture of potential attenuated areas and potential unattenuated areas obtained by emitting a light beam from the recording head; and a controller for correcting intensity of the light beam emitted from the recording head, based on the surface potentials of the latent image area measured by the surface potential measuring unit.

In a further aspect of the invention, an electrophotographic apparatus is provided for emitting a light beam to a photoreceptor to form an electrostatic latent image thereon, and thereafter supplying a toner to the photoreceptor to develop the latent image, the apparatus comprising a charger for charging the photoreceptor; a recording head for forming an electrostatic latent image on the photoreceptor charged by the charger by irradiating the photoreceptor with a light beam modulated according to image data supplied to the recording head; a surface potential measuring unit for measuring surface potentials of a latent image area having a mixture of potential attenuated areas and potential unattenuated areas obtained by emitting a light beam from the recording head; and a controller for correcting the image data supplied to the recording head, based on the surface potentials of the latent image area measured by the surface potential measuring unit.

Other features and advantages of the present invention will be apparent from the following detailed description of the embodiments of the invention.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIG. 1 is a schematic view of an electrophotographic apparatus according to the invention;

FIG. 2 is a block diagram showing a main electrical structure of the electrophotographic apparatus;

FIG. 3 is an explanatory view showing a relationship between the quantity of light to a photoreceptor on an electrostatic drum and surface potential of the photoreceptor;

FIG. 4 is an explanatory view showing variations in a certain image area on the photoreceptor occurring with variations in the surface potential of the area;

FIG. 5 is an explanatory view showing profiles of light beams for forming latent image areas;

FIG. 6 is an explanatory view showing a relationship between the quantity of light to the photoreceptor on the electrostatic drum and surface potential of the photoreceptor;

FIG. 7 is an explanatory view showing a relationship between the quantity of light to the photoreceptor on the electrostatic drum and surface potential of the photoreceptor; and

FIG. 8 is an explanatory view showing screen gradation values.

### DESCRIPTION OF THE PREFERRED EMBODIMENTS

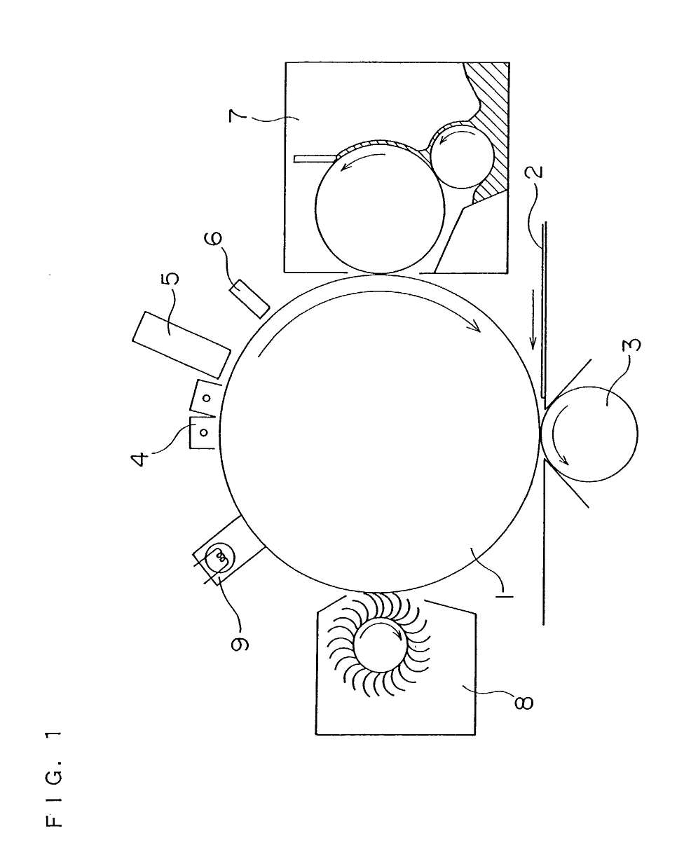

Embodiments of the present invention will be described hereinafter with reference to the drawings. FIG. 1 is a schematic view of an electrophotographic apparatus according to the invention.

This electrophotographic apparatus includes an electrostatic drum 1 with a photoreceptor formed peripherally thereof, and an impression cylinder 3 rotatable while holding printing paper 2 against the electrostatic drum 1.

Arranged around the electrostatic drum 1 are a charger 4 for charging the photoreceptor on the electrostatic drum 1, a recording head 5 for irradiating the charged photoreceptor with light beams to form an electrostatic latent image thereon, a surface electrometer 6 for measuring surface potentials of the photoreceptor on the electrostatic drum 1, a toner feeder 7 for feeding a toner to the periphery of the electrostatic drum 1, a cleaner 8 for removing the toner remaining on the electrostatic drum 1, and a charge eraser 9 for erasing the charge from the periphery of the electrostatic drum 1.

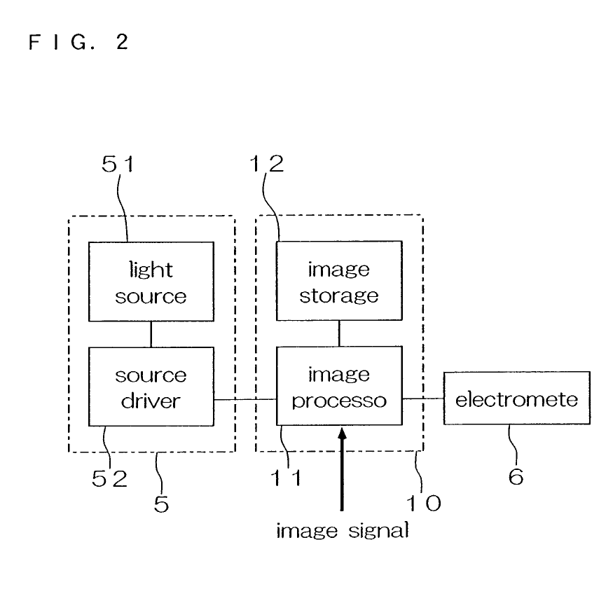

FIG. 2 is a block diagram showing a main electrical structure of the electrophotographic apparatus.

This electrophotographic apparatus includes a controller 10 having an image processor 11 and an image storage unit 12. The controller 10 is connected to the recording head 5 and surface electrometer 6.

The recording head 5 includes a light source 51, and a light source driver 52 for driving the light source 51. The light source 51 is in the form of an LED array having numerous LEDs. The light source driver 52 controls lighting and emission intensity of each LED forming the LED array. That is, the light source driver 52 controls on-off and intensity of a light beam emitted from the light source 51.

The image processor 11 in the controller 10 is formed of a microcomputer or the like, and connected online or offline to an image signal generator not shown. The image processor 11 once stores image signals received from the image signal generator in the image storage unit 12. Based on surface potentials of a latent image area of the photoreceptor measured by the surface electrometer 6, the image processor 11 processes the image signals stored in the image storage unit 12, or controls the light source driver 52 to correct the intensity of the light beam emitted from the light source 51.

The image storage unit 12 in the controller 10 is formed of a storage device such as a RAM or hard disk for storing the image signals received from the image signal generator through the image processor 11. The image storage unit 12 stores also a sample pattern for forming a latent image area, described hereinafter, including areas where the potential of the photoreceptor has attenuated and areas where the potential has not attenuated.

In this electrophotographic apparatus, the periphery of the electrostatic drum 1 rotating clockwise in FIG. 1 is first charged with approximately 700 volts by the action of the charger 4. Next, the recording head 5 scans the periphery of the electrostatic drum 1 with a light beam. In time of scanning with the light beam, a portion of the photoreceptor on the electrostatic drum 1 irradiated with the light beam, due to its light attenuation characteristic, is reduced to approximately 100 volts, whereby an electrostatic latent image is formed on the photoreceptor. At the toner feeder 7, the photoreceptor on the electrostatic drum 1 with the electrostatic latent image contacts the toner, whereby the electrostatic latent image is developed into a toner image. This toner image is transferred to the printing paper 2 as the printing paper 2 passes between the electrostatic drum 1 and the impression cylinder 3 having approximately minus 1,000 volts applied thereto.

In the electrophotographic apparatus having the above construction, a proper quantity of light emitted from the recording head 5 is set beforehand based on a gamma curve representing light attenuation on the photoreceptor. However, the sensitivity of the photoreceptor is variable with a degree of fatigue thereof, and the temperature and humidity of a room in which the electrophotographic apparatus is installed. The quantity of light set beforehand will therefore deviate from a proper quantity of light at any given time. This results in a phenomenon that an image density after a continuous printing operation proves different from an image density at the beginning of the printing operation, or the density of images printed varies from day to day.

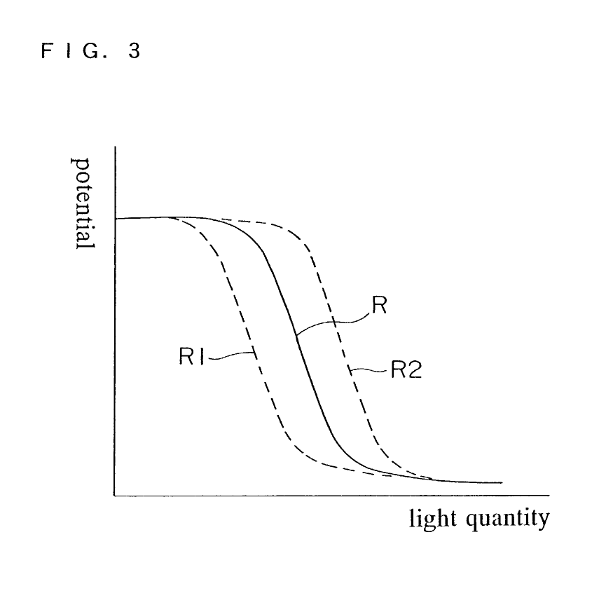

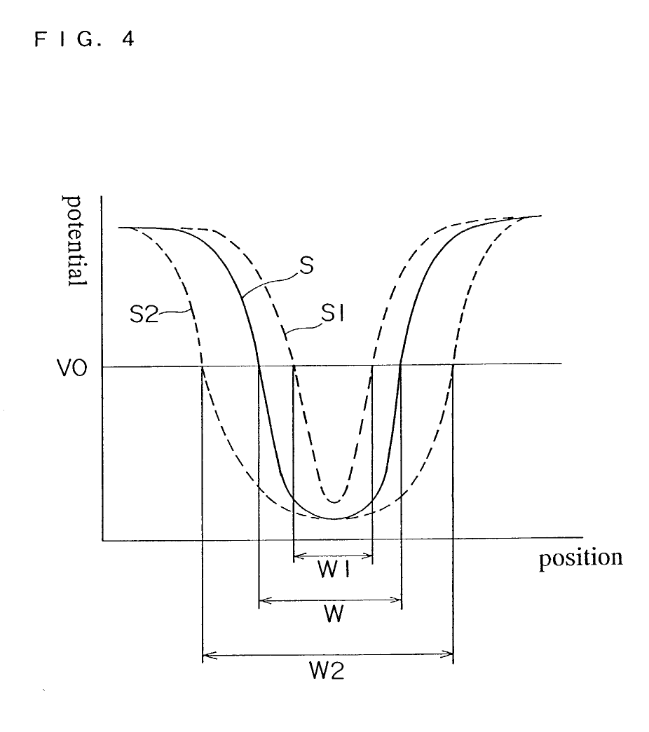

FIG. 3 is an explanatory view showing a relationship between the quantity of light emitted to the photoreceptor on the electrostatic drum 1 and surface potential of the photoreceptor. FIG. 4 is an explanatory view showing variations in a certain image area on the photoreceptor occurring with variations in the surface potential of the area. In these figures, the photoreceptor used has a relatively high gamma value.

Assume that the quantity of light emitted to the photoreceptor on the electrostatic drum 1 and surface potential of the photoreceptor are in a relationship referenced R in FIG. 3. As noted above, the sensitivity of the photoreceptor is variable with a degree of fatigue thereof, and the temperature and humidity of a room in which the electrophotographic apparatus is installed. As a result, the relationship changes to a state referenced R1 or R2 in FIG. 3. In such a case, even with a constant quantity of light, the surface potential of the photoreceptor changes from a state referenced S to a state referenced S1 or S2 in FIG. 4. Consequently, as shown in FIG. 4, even with a constant quantity of light, an image is recorded with a width W changing to W1 or W2.

Thus, in the electrophotographic apparatus in a first embodiment of the invention, the surface electrometer 6 is used to measure surface potentials of a latent image area having a mixture of areas where the potential of the photoreceptor has attenuated, and areas where the potential has not attenuated. Based on the surface potentials of the latent image area measured, the apparatus corrects the intensity of the light beam emitted from the recording head 5.

Specifically, in the electrophotographic apparatus according to the invention, the sample pattern stored in the image storage unit 12 of the controller 10 shown in FIG. 2 is used to form a latent image area having a mixture of areas where the potential of the photoreceptor on the electrostatic drum 1 has attenuated, and areas where the potential has not attenuated. This latent image area is formed, for example, in a non-image portion of the photoreceptor.

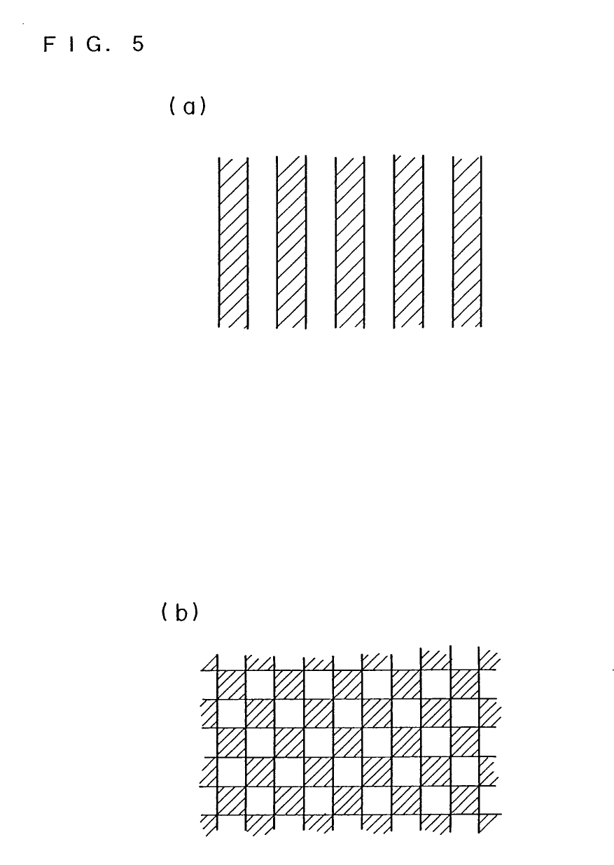

A light beam for forming this latent image area may have a profile with potential attenuated areas and unattenuated areas arranged alternately as shown in FIG. 5(a), or a profile with potential attenuated areas and unattenuated areas staggered as shown in FIG. 5(b)

Subsequently, the surface electrometer 6 is operated to measure an average surface potential of the latent image area formed in the non-image portion of the photoreceptor.

In the electrophotographic apparatus according to the invention, the formation and voltage measurement of such a latent image area are carried out in parallel with an image printing operation. When the quantity of light to the photoreceptor on the electrostatic drum 1 and the sensitivity of the photoreceptor are in a fixed relationship at all times, the surface potential is fixed also, to present no problem. Usually, however, the sensitivity of the photoreceptor varies with a degree of fatigue thereof, and the temperature and humidity of a room in which the electrophotographic apparatus is installed. This results in variations in the surface potential of the latent image area measured by the surface electrometer 6.

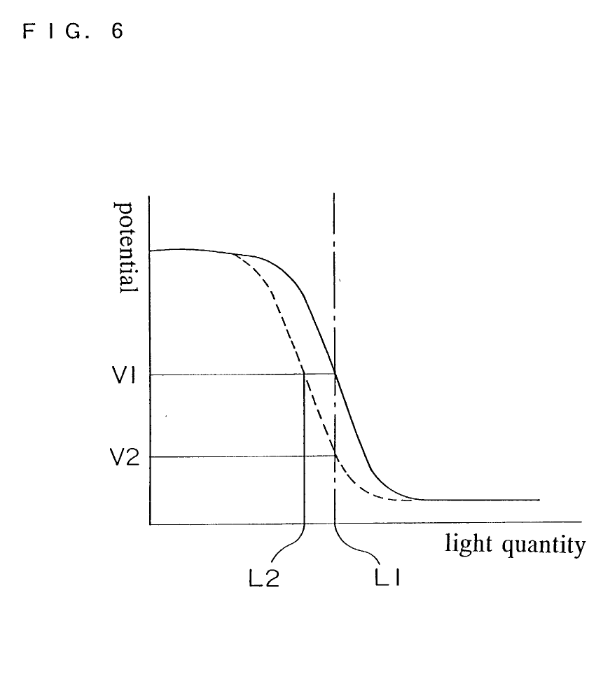

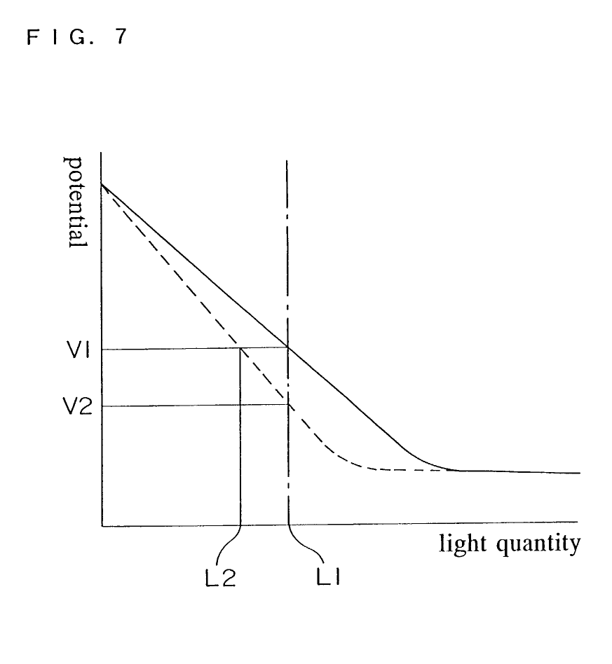

FIGS. 6 and 7 are explanatory views showing a relationship between the quantity of light to the photoreceptor on the electrostatic drum 1 and surface potential of the photoreceptor. In FIG. 6, the photoreceptor used has a relatively high gamma value. In FIG. 7, the photoreceptor used has a relatively low gamma value.

When the relationship between the quantity of light to the photoreceptor and the surface potential of the photoreceptor changes from a state shown in the solid line to a state shown in the broken line in FIGS. 6 or 7, the voltage for exposure with the quantity of light L1 lowers from V1 to V2. With the lowered voltage, a printed image will have a dot percentage higher than a proper value, resulting in an excessive image density of the print.

In the electrophotographic apparatus in the first embodiment of the invention, therefore, the intensity of the light beam emitted from the recording head 5 is corrected based on the surface potentials of the latent image area having a mixture of areas where the potential of the photoreceptor has attenuated, and areas where the potential has not attenuated.

More particularly, when a mean value of surface potentials of the latent image area measured with the surface electrometer 6 decreases from V1 to V2 shown in FIG. 6, the intensity of the light beam emitted from the recording head 5 is lowered from L1 to L2. As a result, prints may be made with a constant dot percentage, i.e. with a constant image density, at all times regardless of variations in the sensitivity of the photoreceptor.

The above adjustment of the intensity of the light beam is performed by the controller 10 controlling the light source driver 52 shown in FIG. 2 to vary the intensity of the light beam emitted from the light source 51. At this time, the controller 10 acts as the “controller for correcting the intensity of the light beam emitted from the recording head 5 based on the surface potential of the latent image area”.

In the above description, the intensity of the light beam is lowered in response to a decrease of the mean value of the surface potentials of the latent image area. When the mean value of the surface potentials of the latent image area increases, the intensity of the light beam may be raised to perform printing with a constant image density as above.

Where an LED array or the like is used as light source 51, the intensity of the light beam is changed as described above by controlling lighting time of the LEDs. That is, an LED array or the like is repeatedly turned on and off within a short time, and it is therefore possible to adjust the intensity of the light beam emitted from the recording head 5 by adjusting a ratio of lighting time. Alternatively, the intensity of the light beam emitted from the recording head 5 may be adjusted by adjusting the voltage or current applied to the light source 51 such as an LED array or the like.

In the first embodiment described above, the density of prints is maintained constant by correcting the intensity of the light beam emitted from the recording head 5 based on the surface potentials of the latent image area. However, the density of prints may be maintained constant by correcting image data supplied to the recording head 5 based on the surface potentials of the latent image area.

A second embodiment employing such a correction mode will be described hereinafter.

In the image recording apparatus according to the second embodiment, as in the first embodiment described above, the surface electrometer 6 is used to measure surface potentials of a latent image area having a mixture of areas where the potential of the photoreceptor has attenuated, and areas where the potential has not attenuated. The image data supplied to the recording head 5 is corrected based on the surface potentials of the latent image area measured by the surface electrometer 6.

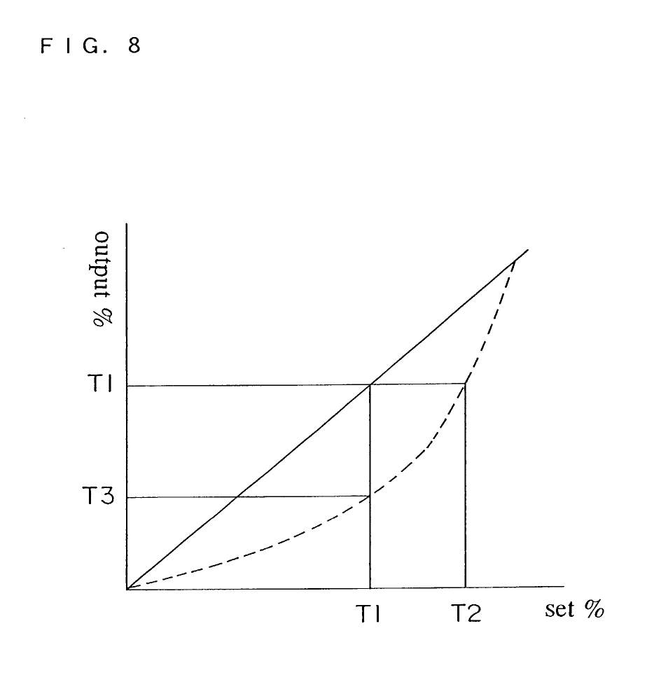

More particularly, a screen gradation correction value is measured from variations in the mean value of the surface potentials of the latent image area measured by the surface electrometer 6. That is, a recognition is made based on variations in the surface potential that, as shown in FIG. 8, the screen gradation correction value has changed from a state shown in the solid line to a state shown in the broken line. A relationship between variations in the surface potential and variations in the screen gradation value is measured such as by experiment in advance, and stored in memory not shown or in the image storage unit 12.

In the state shown in the solid line in FIG. 8, when a set value of dot percentage (set %) is T1, the dot percentage in an image actually outputted (output %) also is T1. However, in the state shown in the broken line in FIG. 8, when a set value of dot percentage is T1, the dot percentage in an image actually outputted becomes T3. In this case, the set value of dot percentage T1 is corrected to T2. As a result, prints may be made with a constant dot percentage, i.e. with a constant image density, at all times regardless of variations in the sensitivity of the photoreceptor.

The above adjustment of the set value of dot percentage is performed by the controller 10 shown in FIG. 2 processing the image signals received from the image signal generator and stored in the image storage unit 12, based on the surface potentials of the latent image area, and correcting the image data supplied to the recording head 5. At this time, the controller 10 acts as the “controller for correcting the image data supplied to the recording head 5 based on the surface potentials of the latent image area measured by the surface electrometer 6”.

In the above embodiment, the latent image area having a mixture of areas where the potential of the photoreceptor has attenuated, and areas where the potential has not attenuated, is formed in a non-image portion of the photoreceptor. Thus, the formation and voltage measurement of the latent image area are carried out in parallel with an image printing operation. However, the latent image area having a mixture of areas where the potential of the photoreceptor has attenuated, and areas where the potential has not attenuated, may be formed in an image portion of the photoreceptor. This arrangement provides an advantage that surface voltages of the latent image area may be measured in a portion actually used for printing. However, an actual printing operation cannot be performed during measurement of the surface voltages of the latent image area.

The present invention may be embodied in other specific forms without departing from the spirit or essential attributes thereof and, accordingly, reference should be made to the appended claims, rather than to the foregoing specification, as indicating the scope of the invention.

This application claims priority benefit under 35 U.S.C. Section 119 of Japanese Patent Application No. 2001-288561 filed in the Japanese Patent Office on Sep. 21, 2001, the entire disclosure of which is incorporated herein by reference.

What is claimed is:

1. An electrophotographic apparatus for emitting a light beam to a photoreceptor to form an electrostatic latent image thereon, and thereafter supplying a toner to the photoreceptor to develop the latent image, said apparatus comprising:
a charger for charging said photoreceptor;
a controller having an image processor and an image storage unit, said image storage unit storing image signals received from an image signal generator, and a sample pattern for forming on said photoreceptor a latent image area having a mixture of potential attenuated areas and potential unattenuated areas, said image processor creating image data for forming an electrostatic latent image based on the image signals received from said image signal generator;
a recording head having a light source, and a light source driver for driving said light source, said recording head forming an electrostatic latent image on said photoreceptor charged by said charger by irradiating said photoreceptor with a light beam modulated according to the image data supplied from said image processor; and
a surface potential measuring unit for measuring surface potentials of said photoreceptor, said surface potential measuring unit measuring surface potentials of said latent image area having a mixture of potential attenuated areas and potential unattenuated areas obtained by emitting a light beam from said recording head to said photoreceptor by using said sample pattern stored in said image storage unit;
wherein said controller corrects at least one of intensity of the light beam emitted from said recording head and the image data supplied to said recording head, based on the surface potentials of said latent image area measured by said surface potential measuring unit.

2. An electrophotographic apparatus as defined in claim 1, wherein said controller corrects the intensity of the light beam emitted from said light source by controlling said light source driver based on the surface potentials of said latent image area.

3. An electrophotographic apparatus as defined in claim 1, wherein said controller corrects the image data supplied to said recording head by causing said image processor to process the image signals stored in said image storage unit based on the surface potentials of said latent image area.

4. An electrophotographic apparatus for emitting a light beam to a photoreceptor to form an electrostatic latent image thereon, and thereafter supplying a toner to the photoreceptor to develop the latent image, said apparatus comprising:
a charger for charging said photoreceptor;
a recording head for forming an electrostatic latent image on said photoreceptor charged by said charger by irradiating said photoreceptor with a light beam modulated according to image data supplied to said recording head;
a surface potential measuring unit for measuring surface potentials of a latent image area having a mixture of potential attenuated areas and potential unattenuated areas obtained by emitting a light beam from said recording head; and
a controller for correcting intensity of the light beam emitted from said recording head, based on the surface potentials of said latent image area measured by said surface potential measuring unit.

5. An electrophotographic apparatus for emitting a light beam to a photoreceptor to form an electrostatic latent image thereon, and thereafter supplying a toner to the photoreceptor to develop the latent image, said apparatus comprising:
a charger for charging said photoreceptor;
a recording head for forming an electrostatic latent image on said photoreceptor charged by said charger by irradiating said photoreceptor with a light beam modulated according to image data supplied to said recording head;
a surface potential measuring unit for measuring surface potentials of a latent image area having a mixture of potential attenuated areas and potential unattenuated areas obtained by emitting a light beam from said recording head; and
a controller for correcting the image data supplied to said recording head, based on the surface potentials of said latent image area measured by said surface potential measuring unit.
